(19) United States
(12) Patent Application Publication
(10) Pub. No.: US 2011/0113063 A1
(43) Pub. Date: May 12, 2011

(54) METHOD AND SYSTEM FOR BRAND NAME IDENTIFICATION

(76) Inventors: Bob Schulman, Menlo Park, CA (US); Sathiya Keerthi Selvaraj, Cupertino, CA (US); Vinay Kakade, Sunnyvale, CA (US); Mani Abrol, Bangalore (IN); Amit Basu, San Jose, CA (US); Arun Shankar Iyer, Bangalore (IN); Philip Bohannon, Cupertino, CA (US)

(21) Appl. No.: 12/615,243

(22) Filed: Nov. 9, 2009

(51) Int. Cl. G06F 17/30

(52) U.S. Cl. 707/771; 707/E17.014

(57) ABSTRACT

A method for identifying a brand name is described herein. The method involves obtaining category keywords associated with a category, designating a subgroup of the category keywords as brand name keywords for a particular brand name, receiving a search term, determining that the search term is a brand name keyword, and identifying the particular brand name corresponding to the brand name keyword.

### INCORPORATION BY REFERENCE

The present application is related to U.S. patent application Ser. No. 12/538,070 filed on Aug. 7, 2009 and U.S. patent application Ser. No. 12/576,011 filed on Oct. 8, 2009, which are both hereby incorporated by reference.

### FIELD OF THE INVENTION

The present application relates to search technologies in general. More specifically, the application relates to brand identification.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

One of the most common tasks in information retrieval is a search based on a query term (e.g., one or more keywords). A query term search involves submission of query term as a list of one or more keywords by a user with the goal of receiving a ranked list of documents (or references to the documents) from a document collection based on relevance to the query term.

In response, a search engine typically searches for the query term in one or more documents (e.g., websites), and returns the documents that include occurrences for the query term or the documents that have paid the search engine to show up as a search result for that query term.

However, simply searching for a query term within a document may not be sufficient to identify desired search results. For example, a user looking for a store selling baby cribs near San Jose, Calif. may enter the query term “baby crib near san jose, ca”. In this case, the search engine may simply return any web page that includes one or more of the keywords in the query term, which may result in an incredible number of hits without providing focused results for the user. Another search engine may simply return any stores with the name “baby crib” near San Jose, Calif. This will likely result in very few hits since most furniture stores sell many different products and accordingly, would not name the store based on one product, e.g., “baby crib”.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a system architecture in accordance with one or more embodiments;

FIG. 2 shows a flow chart related to determining category keywords for a category, in accordance with one or more embodiments;

FIG. 3 shows a flow chart related to selecting brand name keywords for a brand name from category keywords, in accordance with one or more embodiments;

FIG. 4 shows a flow chart related to selecting brand name keywords using brand-specific product names, in accordance with one or more embodiments;

FIG. 5 shows a flow chart related to identifying brand names from query terms, in accordance with one or more embodiments;

FIG. 6 is a block diagram illustrating a computer system that may be used in implementing an embodiment of the present invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Several features are described hereafter that can each be used independently of one another or with any combination of the other features. However, any individual feature might not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in the specification.

### Overview

A method for identifying brand names based on a query term is provided. The method includes building a database of brand name keywords for each of a set of brand names. A query term submitted by a user or an application is compared to the brand name keywords to determine any matches. If the query term matches one or more brand name keywords, the corresponding brand name(s) is identified. Thereafter, the brand name may be presented and/or information associated with the brand name may be presented.

Determining brand name keywords for a particular brand name may include obtaining category keywords associated with a category corresponding to the brand name. Category keywords may be identified by obtaining a set of brand names associated with a category, and thereafter obtaining previously used query terms for searching for the set of brand names. For each query term, corresponding related keywords may be determined, and the query term may be designated as a category keyword if at least a threshold number of the corresponding related words for the query term are product-intent keywords for two or more brands.

Determining brand name keywords for a particular brand name may include selecting a subgroup of category keywords that meet an affinity criteria for the brand name. The subgroup of category keywords may be selected based on an occurrence of the category keyword in a document associated with the brand name.

Determining brand name keywords for a particular brand name may include obtaining brand-specific product names. For each brand-specific product name, corresponding related keywords may be determined, and the brand-specific product name may be designated as a candidate keyword, if at least a threshold number of the corresponding related keywords are product-intent keywords. Further, the candidate keywords may then be designated as brand name keywords if the candidate keywords meet an affinity criteria.

Although specific components are recited herein as performing the method steps, in other embodiments, agents, or mechanisms acting on behalf of the specified components may perform the method steps. Further, although the invention is discussed with respect to components distributed over multiple systems, other embodiments of the invention include systems where all components are on a single system. While specific embodiments of the invention are described, the techniques described herein are not limited to the disclosed embodiments of the invention and the techniques described herein may be applicable to other embodiments.

### System Architecture and Functionality

Although a specific system architecture is described to perform an embodiment of the invention, other embodiments of the invention are applicable to any architecture that can be used for brand identification.

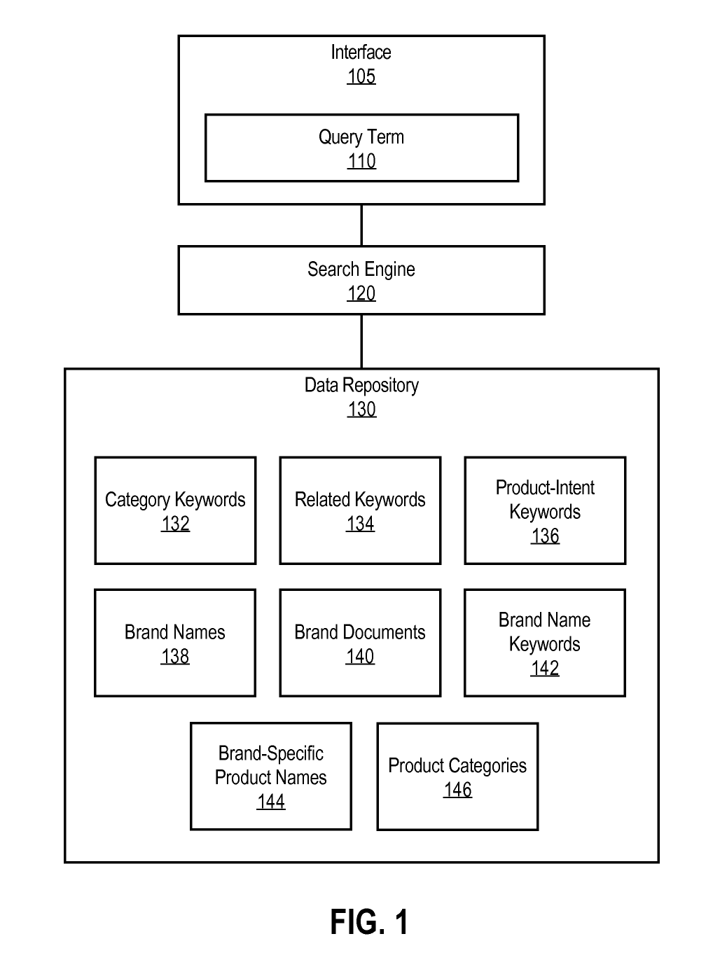

FIG. 1 shows a system architecture in accordance with one or more embodiments. As shown in FIG. 1, the system includes an interface (105), a search engine (120), and a data repository (130).

In an embodiment, the interface (105) corresponds to any sort of interface adapted for use to access the search engine (120) and any services provided by the search engine (120). The interface (105) may be a web interface, graphical user interface (GUI), command line interface, or other suitable interface which allows a user to perform a search. The interface may correspond to an Application Programming Interface (API) for use by another application to perform a search. The interface (105) may be displayed on a client machine (such as personal computers (PCs), mobile phones, personal digital assistants (PDAs), and/or other digital computing devices of the users) or may be accessed remotely in conjunction with a client machine to provide a search criteria to the search engine (120). For example, the interface (105) may be a part of a web browser application or simply an application for browsing and/or searching local files on a client machine or local network.

In an embodiment, the interface (105) allows for input of a query term (110) to perform a search. The query term (110) generally represents any keywords, numbers, characters, symbols, selections, etc. that may be submitted by a user or application to perform a search. The query term (110) may include a general product, a brand-specific product, a product category, or any other suitable content. The query term (110) may be submitted with additional information (e.g., a location and/or information being sought). Examples of query terms include: “shoes”, “shoes near San Jose, Calif.”, or “baby crib near San Jose, Calif., hours of operation”. The query term (110) may be entered to search for specific brand names associated with the query term (110), for information (e.g., where sold) related to brand names associated with the query term (110), or for any other suitable data.

In one or more embodiments of the invention, the data repository (130) generally represents any data storage device (e.g., local memory on a client machine, multiple servers connected over the internet, systems within a local area network, a memory on a mobile device, etc.) known in the art which may be searched based on a query term (110) to obtain search results. Elements or various portions of data shown as stored in the data repository (130) may be stored in a single data repository or may be distributed and stored in multiple data repositories (e.g., servers across the world). In one or more embodiments of the invention, the data repository (130) includes flat, hierarchical, network based, relational, dimensional, object modeled, or data files structured otherwise. For example, data repository (130) may be maintained as a table of a SQL database. In addition, data in the data repository (130) may be verified against data stored in other repositories.

In one or more embodiments, the data repository (130) includes category keywords (132), related keywords (134), product-intent keywords (136), brand names (138), brand documents (140), brand name keywords (142), brand-specific product names (144), product categories (146). Data stored in the data repository (130) may be omitted or overlap with other data stored in the data repository (130). Data stored in the data repository (130) may be stored in association with another data.

In an embodiment, brand names (138) generally represent any text, symbols, trademarks, images, etc. that identify a brand or manufacturer. Examples of brand names (138) include “Nike” (Nike® is a registered trademark of Nike, Inc., Beaverton, Oreg.), “Apple” (Apple® is a registered trademark of Apple, Inc., Cupertino, Calif.), etc. Each brand name (138) may be associated with a corresponding set of information. For example, a brand name (138) may be associated with a set of stores where products with that brand name are sold. The brand name (138) may be associated with statistics such as revenue for the corresponding brand manufacturer. The brand name (138) may be associated with information such as sales or discounts for the brand name (138).

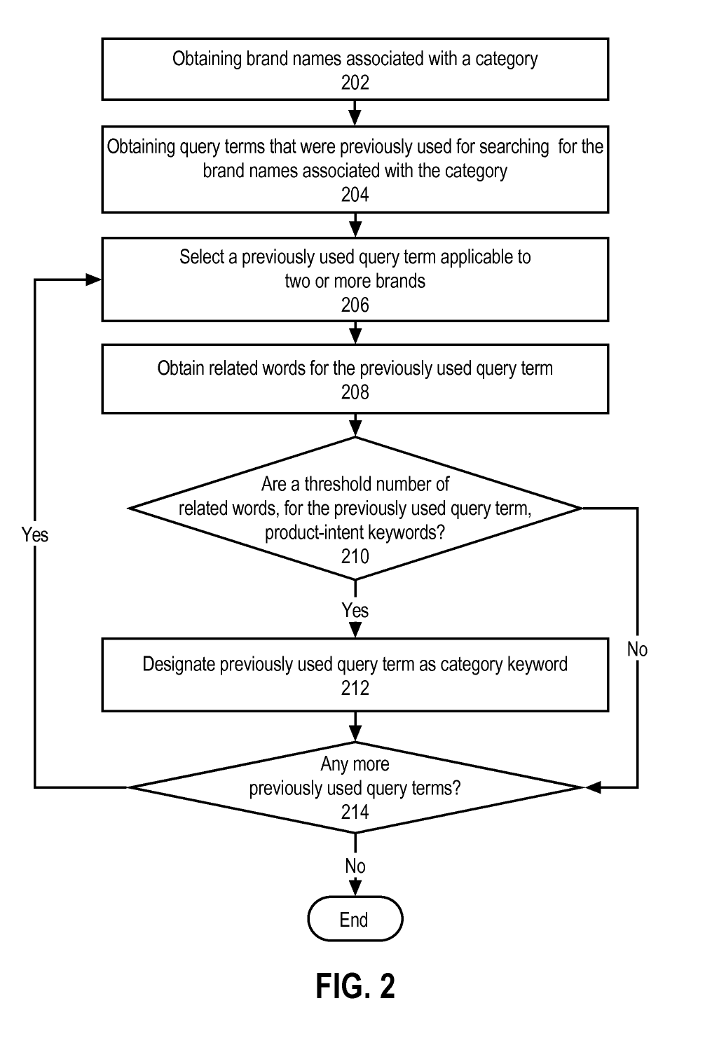

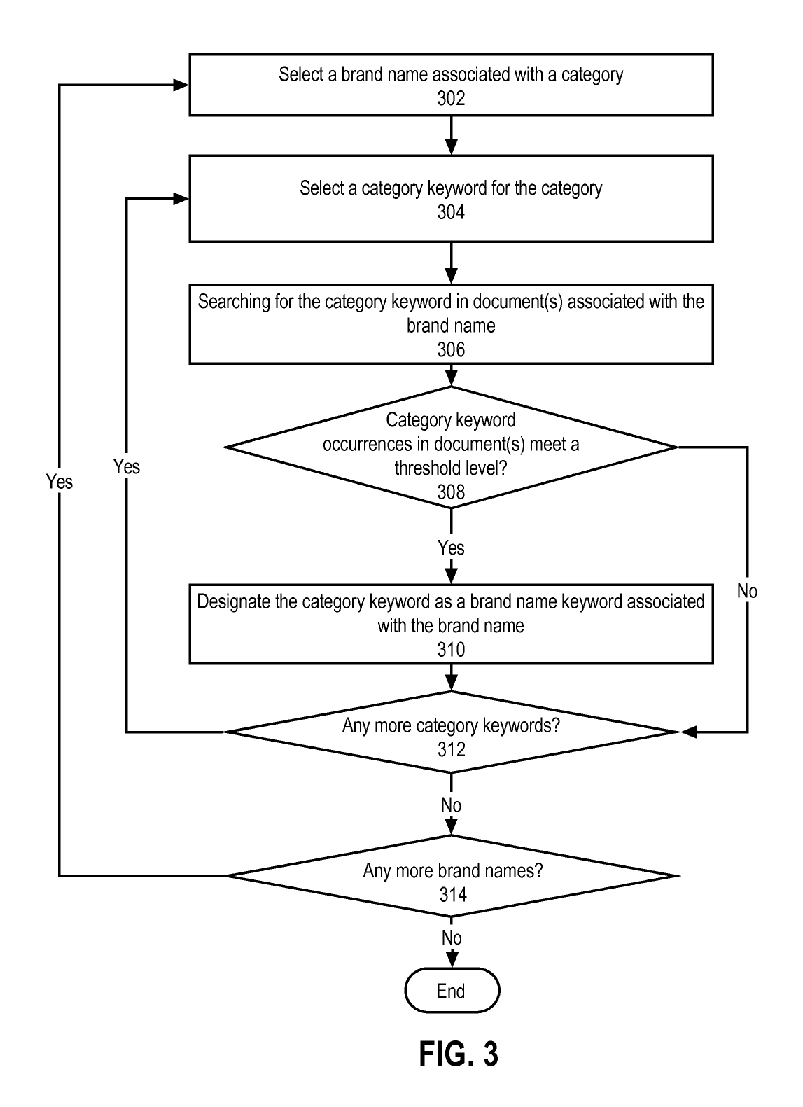

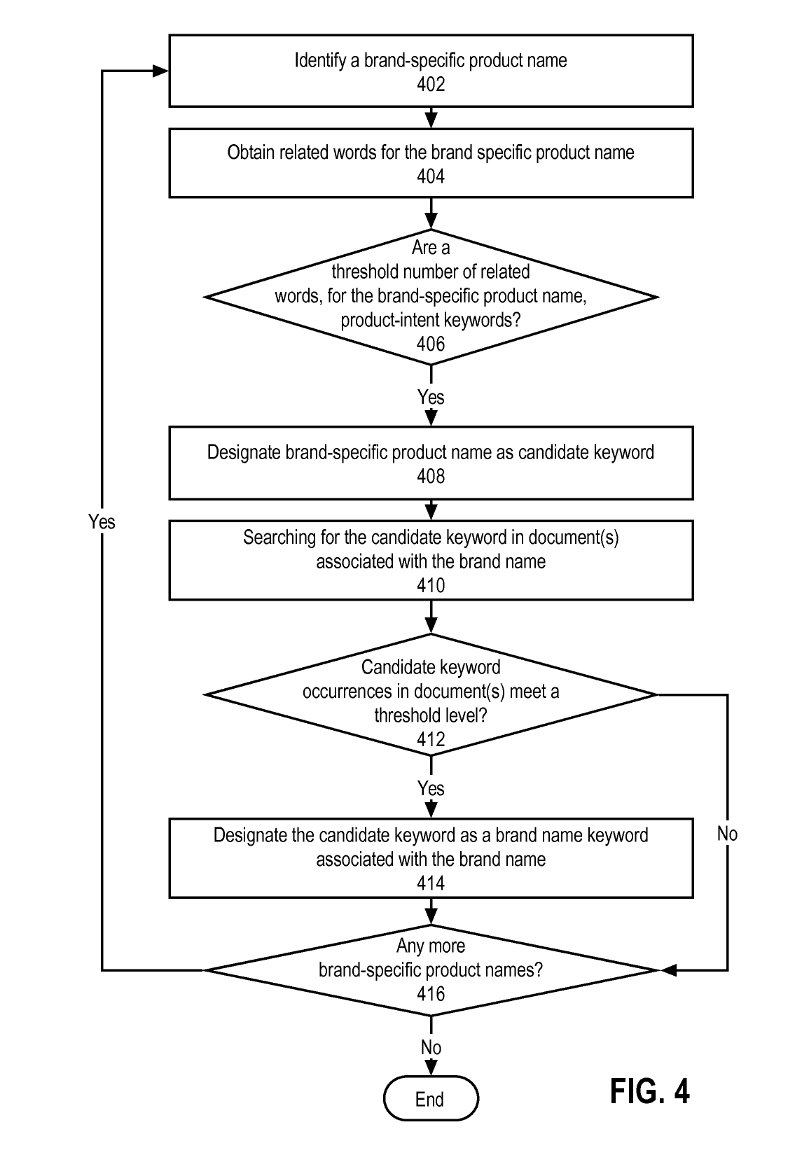

In an embodiment, each of the brand names (138) are associated with brand name keywords (142). Brand name keywords (142) for a brand name (138) generally represent one or more keywords that are determined to have a particular relationship with that brand name (138). Methods for determining the brand name keywords (142) for a brand name (138), in accordance with one or more embodiments, are described below in relation to FIG. 2, FIG. 3, and FIG. 4. Multiple methods (e.g., as shown in FIG. 3 and FIG. 4) may be used together to obtain all the brand name keywords for a single brand name. Brand name keywords (142) may be unique to a single brand name (138) or correspond to multiple brand names (138). Brand name keywords (142) corresponding to a brand name (138) may be ranked for that particular brand name (138). For example, the brand name keywords (142) may be ranked based on relevance to a particular brand name (138), affinity with the brand name (138), or based on any other suitable criteria. In an embodiment, a ranking of brand name keywords (142) may be used. Brand name keywords (142) for a particular brand name (138), may include the types of products the brand makes and/or brand-specific products (e.g., “Air Jordon®” made by Nike®, Air Jordan® is a registered trademark of Nike, Inc., Beaverton, Oreg.). In an embodiment, a different set of brand name keywords (142) may be obtained for each language or country/geographical region. For example, slang used in a particular country to refer to product name, product-specific name, or a brand name (138) may be designated as a brand name keyword (142) associated with the corresponding brand name (148) for searches performed by users in that country.

Table 1 below shows example lists of brand name keywords (142) for brand names (138):

TABLE 1

| Brand Name | Brand Name Keywords (Examples) |
|---|---|
| Oeuf ® | crib, oeuf crib, furniture, |
| (Baby Furniture | oeuf furniture, baby lounger, |
| Brand) | oeuf baby lounger, baby |
| Oeuf ® is a | furniture, oeuf baby furniture, |
| registered | toddler bed, oeuf toddler bed, |
| trademark of Oeuf, | lounger, oeuf lounger, bouncer, |
| LLC, New York, New | oeuf bouncer, oeuf sparrow |
| York | crib, bed, oeuf bed, baby |
| | bouncer, oeuf baby bouncer, |
| | dresser, oeuf dresser, baby |
| | crib, oeuf baby crib, oeuf |
| | changing station, beds, oeuf |
| | beds, toddler bed conversion |
| | kit, oeuf toddler bed |
| | conversion kit, loungers, oeuf |
| | loungers, crib mattress, oeuf |
| | crib mattress, oeuf furniture |
| | sparrow, storage, oeuf storage, |
| | nightstand, oeuf nightstand, |
| | mattress, oeuf mattress, home |
| | furniture, oeuf home furniture, |
| | hutch, oeuf hutch, cart, oeuf |
| | cart, wardrobe, oeuf wardrobe, |
| | dressers, oeuf dressers, twin |
| | bed, oeuf twin bed, drawers, |
| | oeuf drawers, mattress pad, |
| | oeuf mattress pad, furniture |
| | storage, oeuf furniture |
| | storage, furniture for babies, |
| | oeuf furniture for babies, etc. |
| Drexel Heritage ® | furniture, drexel heritage |
| (Large Furniture | furniture, furnishings, drexel |
| Brand) | heritage furnishings, bedroom |
| Drexel Heritage ® | furniture, drexel heritage |
| is a registered | bedroom furniture, sofa, |
| trademark of | drexel heritage sofa, sofas, |
| Drexel Heritage | drexel heritage sofas, beds, |
| Furniture | drexel heritage beds, chairs, |
| Industries, Inc., | drexel heritage chairs, dining |
| High Point, North | room furniture, drexel heritage |
| Carolina | dining room furniture, bed, |
| | drexel heritage bed, dining |
| | table, drexel heritage dining |
| | table, table, drexel heritage |
| | table, drexel heritage high |
| | point nc, desk, drexel heritage |
| | desk, tables, drexel heritage |
| | tables, dining tables, drexel |
| | heritage dining tables, |
| | armoire, drexel heritage |
| | armoire, drexel heritage at |
| | home in tuscany, entertainment |
| | center, drexel heritage |
| | entertainment center, coffee |
| | table, drexel heritage coffee |
| | table, dresser, drexel heritage |
| | dresser, office furniture, |
| | drexel heritage office |
| | furniture, bar stools, drexel |
| | heritage bar stools, coffee |
| | tables, drexel heritage coffee |
| | tables, desks, drexel heritage |
| | desks, chair, drexel heritage |
| | chair, china cabinet, drexel |
| | heritage china cabinet, dining |
| | chairs, drexel heritage dining |
| | chairs, mirrors, drexel |
| | heritage mirrors, rugs, drexel |
| | heritage rugs, buffet, drexel |
| | heritage buffet, leather sofa, |
| | drexel heritage leather sofa, |
| | etc. |

As shown in Table 1, brand name keywords (142) (e.g., furniture) may be associated with multiple brand names (138) (e.g., Oeuf®, and Drexel Heritage®). Brand name keywords (142) (e.g., oeuf crib) may also be uniquely associated with a single brand name (138) (e.g., Oeuf®). The number of brand name keywords (142) for each brand name (138) may vary. In an embodiment, only the top x ranked brand name keywords (142) for a particular brand name (138) may be used, where x is predetermined by a user, a developer, an application, or other suitable entity.

In an embodiment, brand documents (140) generally represent any data file associated with the brand name (138). Brand documents (140) may include information about the brand name (138) such as products sold under the brand name (138), product-specific names, stores that sell the brand names (138), prices associated with brand name (138) products, or any other suitable information associated with the brand name (138). Examples of a brand document (140) include a website associated with the brand name (138), a locally stored text file, advertisement materials for a brand name (138), etc. Although shown as stored in the data repository (130), brand documents may be dynamically created at runtime by, for example, performing a search (e.g., on a personal computer, intranet, local area network, internet, world wide web, etc.) to collect brand documents (140) associated with a brand name (138). In an embodiment, brand documents (140) may be limited to a specific documents to generate more accurate results. For example, the homepage associated with a brand name (138) may be used as the only the brand document (140) for the brand name (138).

In an embodiment, category keywords (132) generally represent one or more keywords that make up a category signature for a product category (146). Different product categories (146) may represent different types of product groups (e.g., men's clothing, sportswear, formal wear, network cards, laptops, sports cars, shoes, dress shoes, furniture, baby furniture, etc.). The steps for determining the category keywords for a particular product category (146) are described below in relation to FIG. 2. The category keywords (132) generally include products within a product category (146) without being specific to any particular brand name (138). The category keywords (132) generally do not include brand-specific products (e.g., Air Jordan®, Air Jordan® is a registered trademark of Nike, Inc., Beaverton, Oreg.).

Table 2 below shows an example category keywords (132) for a furniture product category (146):

TABLE 2

| Category Name | Category Keywords (Examples) |
|---|---|
| Furniture | furniture, chairs, chair, |
| | furniture chairs, table, beds, |
| | sofa, tables, bed, furniture |
| | bedroom, bedroom furniture, |
| | furniture sofa, desk, |
| | office furniture, furniture |
| | sofas, sofas, furniture beds, |
| | furniture desk, bar stools, |
| | desks, furniture home, |
| | furniture chair, furniture |
| | dining room, cabinets, |
| | furniture armoire, baby |
| | furniture, furniture desks, |
| | furniture for kids, furniture |
| | bed, entertainment center, |
| | furnishings, bedroom sets, |
| | cribs, coffee table, couches, |
| | bookcase, dresser, couch, |
| | furniture dining, entertainment |
| | centers, armoire, crib, dining |
| | table, dining room furniture, |
| | furniture kids, mattress, |
| | furniture tables, furniture |
| | bedroom sets, sectional, kids |
| | furniture, bedroom set, |
| | furniture entertainment center, |
| | recliners, dining tables, bar |
| | stool, dining set, dining |
| | furniture, seating, furniture |
| | sectionals, leather furniture, |
| | furniture leather, patio |
| | furniture, bookcases, furniture |
| | living room, leather sofa, |
| | coffee tables, furniture bar |
| | stools, cabinet, stools, tv |
| | stand, furniture bookcase, |
| | bench, furniture coffee table, |
| | tv stands, recliner, home |
| | furnishings, furniture table, |
| | dining sets, ottoman, rugs, |
| | outdoor furniture, computer |
| | desk, bunk beds, furniture |
| | accessories, living room |
| | furniture, furniture antique, |
| | etc. |

In an embodiment, related keywords (134) for any particular term generally represent different meanings of the particular term. The related keywords (134) for a particular term are frequently queried terms, determined based on web search logs, that are found in the top k search results for the particular term. For example, for a term “bush”, the search results will include various documents about bush as president, bush as in trees/bush of roses and bush as in the furniture brand. These pages may then be searched to identify occurrences of frequently used query terms, based on web search logs. The frequently used query terms that are found in the various documents are then designated as the related words (e.g., “president”, “washington dc”, “george”, “rose”, “furniture”, “chair”, “table”).

In an embodiment, product-intent keywords (136) generally represent one or more keywords that are associated with products. Product-intent keywords may include keywords that have historically been shown to be used to search for product related information. Product-intent keywords may include keywords that are commonly used for referring to products (e.g., words in a shopping catalog). Product-intent keywords may include keywords that have been bid on by product vendors for search engine queries. For example, a furniture company may bid on a word “bed” by paying a search engine to display a sales website within the first few search results for a query term “bed”. Product-intent keywords may also include query terms that have led to purchases.

In an embodiment, brand-specific product names (144) generally represent any specific product lines/models for a brand. Air Force One® is an example a brand-specific product name (e.g., shoes) sold under the brand name Nike®. Brand-specific product names (144) may also include a brand name appended to a product name. For example, “Nike Shoes”, “Apple Computer”, “Oeuf furniture” are brand names appended with a product sold under that brand name (Nike®, Apple®, and Oeuf® are registered trademarks). Brand-specific product names (144) may also include slang terms that are used to refer to specific products. For example, the brand-specific product name “fatheads” is a slang term used to refer to Air Force One® shoes by Nike®.

### Determining Category Keywords for a Category

FIG. 2 shows a flow chart related to determining category keywords for a category, also referred to herein as a category signature, in accordance with one or more embodiments. One or more of the steps described below may be omitted, repeated, and/or performed in a different order. Accordingly, the specific arrangement of steps shown in FIG. 2 should not be construed as limiting the scope of the invention. Further, the steps shown below may be modified based on the data structure used to store the data.

Initially, brand names associated with a category are obtained, in accordance with one or more embodiments (Step 202). The brand names associated with a category may be obtained by querying a database, receiving input from a user, receiving input from an application, or by any other suitable means. The brand names associated with a category may be obtained by scraping or otherwise obtaining data from a vendor website. For example, a vendor website may have a category called bedroom furniture with a corresponding set of products for sale. The brand names of the products may be obtained and associated with the bedroom furniture category. In another example, the brand name Oeuf® may have a known association with the baby furniture category.

In an embodiment, query terms that were previously used for searching for the brand names associated with a category are obtained (Step 202). The previously used query terms may be obtained through data mining and/or analyzing prior searches made by users. For example, search queries that led to a user selecting an Oeuf® baby crib from the search results may first be identified. A query term “baby crib” which may determined to be a frequent query term resulting in a user selecting the Oeuf® baby crib and accordingly, be determined to be a previously used query term for the Oeuf® brand name. A list of previously used query terms for each brand name may be accessed to identify previously used query terms for that brand name.

In an embodiment, a previously used query term applicable to two or more brands is selected (Step 206) and related words for the previously query term are obtained (Step 208). Obtaining the related words for the previously used query term may include performing a web search (or other search) to obtain documents (e.g., web pages, text documents, pdfs, etc.) A predetermined number, e.g. k, of the top search results may then be searched for frequently queried terms. The frequently queried terms are terms that have most frequently used to perform a search as noted in web search logs. The frequently queried terms that appear in the top k search results for the previously used query term are then designated as the related words for that previously used query term.

The related words for each previously used query term, applicable to two or more brands, are then compared to a database of product-intent keywords to determine how many of the related words are product-intent keywords. If at least a threshold number (e.g., absolute value or percentage) of related words for a previously used query term, match a product-intent keyword (Step 210), then the previously used query term is designated as a category keyword (Step 212). In an embodiment, the rank of a previously used query term as a category keyword may be depend on the number of related words that match the product-intent keywords.

Designating the previously used query term as a category keyword may involve storing the previously used query term in association with a category. For example, if “baby crib” is a previously used query term that is to be designated as a category keyword, then “baby crib” may be stored as a category keyword in association (e.g., in a table or column) with the category “furniture” or the category “baby furniture”. The steps may then be repeated for any more previously used query terms (Step 214).

### Selecting Brand Name Keywords for a Brand Name from Category Keywords

FIG. 3 shows a flow chart related to selecting brand name keywords for a brand name from category keywords, in accordance with one or more embodiments. One or more of the steps described below may be omitted, repeated, and/or performed in a different order. Accordingly, the specific arrangement of steps shown in FIG. 3 should not be construed as limiting the scope of the invention. Further, the steps shown below may be modified based on the data structure used to store the data.

Initially, a brand name associated with a category is selected, in accordance with one or more embodiments (Step 302). The brand name may be associated with multiple categories and the process may be repeated for the brand name and additional categories. Thereafter, a category keyword is selected (Step 304) to determine whether to designate the category keyword as a brand name keyword for that category. Category keywords may be selected at random, based on an alphabetical order, based on a ranking, or on any other suitable criteria.

In an embodiment, the category keyword is searched for in a document(s) associated with the brand name (Step 306). A number of times the category keyword appears in the document may be identified. A modification of the category keyword may also be searched for (e.g., plural form or singular form of the same category keyword). Searching the document associated with the brand name may involve searching a local storage device or performing a search over a network (e.g., searching for the category keyword on a website associated with the brand name).

In an embodiment, if the number of occurrences of the category keyword match a predetermined threshold level then the category keyword is designated as a brand name keyword associated with the brand name (Step 310). Designating a category keyword as a brand name may include storing the category keyword as a brand name keyword in association with the brand name. Designating a category keyword as a brand name keyword may also include storing the brand name in association with the category keyword. For example, a linked list, an array of brand name keywords, or a table of brand name keywords may be maintained for each brand name.

In an embodiment, if there are any more category keywords (Step 312), then the process may be repeated by selecting the additional category keywords for a category. Furthermore, if there are additional brand names (Step 314), then the process may be repeated by selecting the additional brand names.

### Selecting Brand Name Keywords from Brand-Specific Product Names

FIG. 4 shows a flow chart related to selecting brand name keywords using brand-specific product names, in accordance with one or more embodiments. One or more of the steps described below may be omitted, repeated, and/or performed in a different order. Accordingly, the specific arrangement of steps shown in FIG. 4 should not be construed as limiting the scope of the invention. Further, the steps shown below may be modified based on the data structure used to store the data.

In an embodiment, brand-specific product names are identified (Step 402). Brand-specific product names may be identified based on official information received from a manufacturer of a brand name. Brand-specific product names may be identified based on common query terms used to refer to a brand-specific product name. Brand-specific product names may also be identified based on slang for a brand-specific product name.

Next, related words for the brand-specific product name (Step 404) are compared against a database of product-intent keywords (Step 406).

The related words for each brand-specific product name (Step 404) are then compared to a database of product-intent keywords to determine how many of the related words are product-intent keywords. If at least a threshold number of related words for a product-specific brand name, match a product-intent keyword (Step 406), then the brand-specific product name is designated as a candidate keyword (Step 408).

A candidate keyword is a candidate for being designated as a brand name keyword if the candidate keyword satisfies an affinity criteria. To determine if the candidate keyword satisfies an affinity criteria, the candidate keyword is searched for in a document(s) associated with the brand name (Step 410). If the occurrences of the candidate keyword in the document(s) match at least a threshold level, then the candidate keyword is designated as a brand name keyword associated with the brand name (Step 414). The process is repeated if there are any more brand-specific product names associated with the brand name (Step 416). Accordingly, a set of brand name keywords for a particular brand name may be obtained.

### Identifying Brand Names from Query Terms

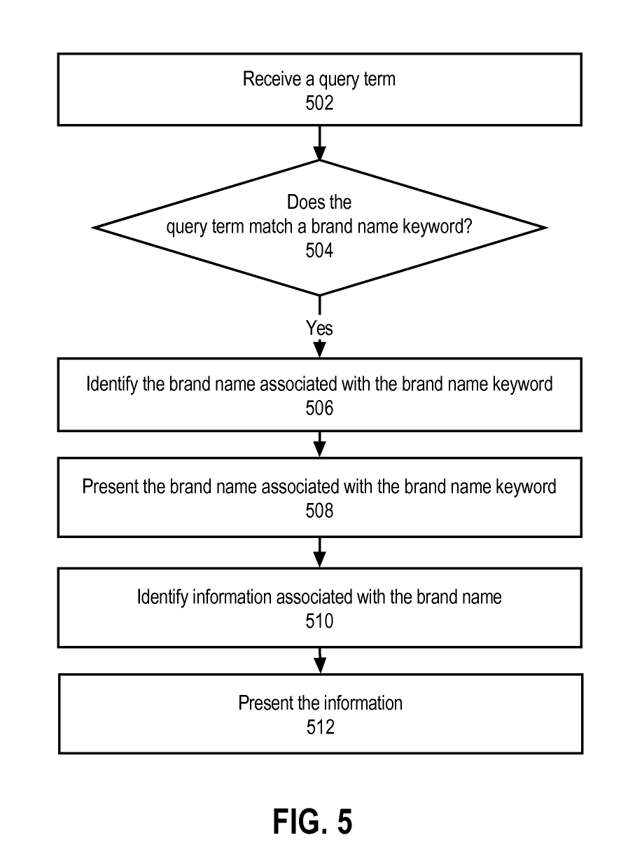

FIG. 5 shows a flow chart related to identifying brand names from query terms, in accordance with one or more embodiments. One or more of the steps described below may be omitted, repeated, and/or performed in a different order. Accordingly, the specific arrangement of steps shown in FIG. 5 should not be construed as limiting the scope of the invention. Further, the steps shown below may be modified based on the data structure used to store the data.

In an embodiment, a query term is received (Step 502). A query term may be received from a user (e.g., via a user interface) or from an application (e.g., via an application programming interface) to obtain brand name identification or to obtain information associated with the brand names. For example, a query term “mahogany chairs” may be received to obtain brand names that sell mahogany chairs, or to obtain information associated with the brand names (e.g., the stores which carry the brand names that include mahogany chairs in their product line-up).

In an embodiment, brand name keywords associated with different brand names are searched to identify a match with the query term. If the query term matches a brand name keyword (Step 504), then the corresponding brand name associated with the brand name keyword is identified (Step 506). For example, the query term “mahogany chairs” may be identified within a set of brand name keywords for the brand name “Drexel Heritage®”. Based on the identification of the brand name keyword, Drexel Heritage® may be identified.

In an embodiment, the brand name associated with the brand name keyword is presented (Step 508). Presenting the brand name may include displaying the brand name, returning data (e.g., to another application) indicating the brand name, printing the brand name, etc. In the above example, Drexel Heritage® may be returned as one of the search result(s) for the query term “mahogany chairs”.

In an embodiment, information associated with the brand name may be identified (Step 510). For example, the known vendors/stores that sell Drexel Heritage® may be identified. The price ranges associated with the Drexel Heritage® brand in general, or with Drexel Heritage® mahogany chairs may be determined. Consumer reviews and/or feedback for Drexel Heritage® products or Drexel Heritage® mahogany chairs may be identified. Any other suitable information associated with the identified brand name may also be identified.

In an embodiment, the information is presented (Step 512). Presenting the information may include displaying the information, returning data (e.g., to another application) indicating the information, printing the information, etc. In the above example, the address and/or map of a store selling Drexel Heritage® mahogany chairs may be displayed on a user interface. Furthermore, if the query term included a location (e.g., “mahogany chairs near San Jose, Calif.), the information presented may be relevant to that location. For example, a listing of stores that sell Drexel Heritage® mahogany chairs near San Jose, Calif. may be displayed on a website.

### Hardware Overview

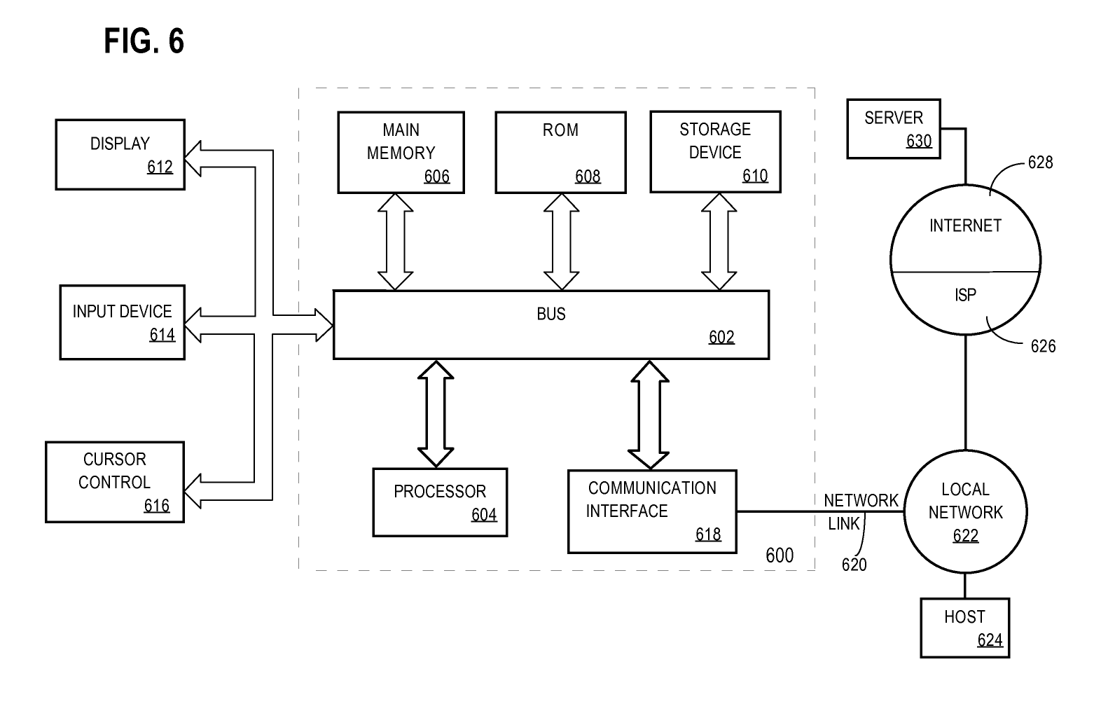

FIG. 6 is a block diagram that illustrates a computer system 600 upon which an embodiment of the invention may be implemented. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

The invention is related to the use of computer system 600 for implementing the techniques described herein. According to one embodiment of the invention, those techniques are performed by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a machine to operation in a specific fashion. In an embodiment implemented using computer system 600, various machine-readable media are involved, for example, in providing instructions to processor 604 for execution. Such a medium may take many forms, including but not limited to storage media. Storage media includes both non-volatile media and volatile media. Non-volatile media includes, for example, optical or magnetic disks, such as storage device 610. Volatile media includes dynamic memory, such as main memory 606. All such media must be tangible to enable the instructions stored on the media to be detected by a physical mechanism that reads the instructions into a machine.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, or any other medium from which a computer can read.

Various forms of computer-readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution. In this manner, computer system 600 may obtain application code in the form of a carrier wave.

### Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
obtaining a plurality of category keywords associated with a category;
designating a subgroup of category keywords of the plurality of category keywords, that meet an affinity criteria for a brand name, as brand name keywords associated with the brand name;
receiving a search term;
determining that the search term is a brand name keyword of the plurality of brand name keywords associated with the brand name;
responsive to determining that the search term is a brand name keyword of the plurality of brand name keywords associated with the brand name, identifying the brand name,
wherein the method is performed by a computing device comprising a processor.

2. The method as recited in claim 1, wherein designating the subgroup of category keywords as brand name keywords comprises determining that each category keyword of the subgroup of category keywords is found in a document associated with the brand name.

3. The method as recited in claim 2, wherein the document is a website associated with the brand name.

4. The method as recited in claim 1, wherein selecting the subgroup of category keywords comprises determining that each category keyword of the selected subgroup of category keywords is found a predetermined number of times in a document associated with the brand name.

5. The method as recited in claim 1, wherein obtaining the plurality of category keywords associated with the category comprises:
obtaining a plurality of brand names associated with the category;
obtaining a plurality of previously used query terms for searching for one or more brand names in the plurality of brand names.

6. The method as recited in claim 5, wherein obtaining the plurality of category keywords associated with the category further comprises:
for each previously used query term,
determining a plurality of related keywords;
if at least a threshold number of related keywords in the plurality of related keywords match a plurality of product-intent keywords, designate the previously used query term as a category keyword.

7. The method as recited in claim 5, wherein determining a plurality of related keywords for each previously used query term comprises:
performing a web search for the previously used query term to obtain to top k document results from the web search, wherein k is a predetermined number;
searching the top k document results for the occurrence of frequently queried words determined based on web search logs;
designating the most frequently queried words found in the top k document results for the previously used query term as related words for the previously used query term.

8. The method as recited in claim 1, further comprising presenting the brand name.

9. The method as recited in claim 1, further comprising
identifying a store name associated with the brand name;
presenting a store name associated with the brand name.

10. A method comprising:
obtaining a plurality of brand-specific product names;
for each brand-specific product name, performing steps comprising:
(a) determining a plurality of related keywords;
(b) if at least a threshold number of related keywords in the plurality of related keywords match a plurality of product-intent keywords, then designating the brand-specific product name as a candidate keyword;
(c) if the candidate keyword satisfies an affinity criteria for a brand name, then designating the candidate keyword as a brand name keyword of a plurality of brand name keywords for the brand name;
receiving a search term;
determining that the search term matches one or more brand name keywords of the plurality of brand name keywords associated with the brand name;
responsive to determining that the search term matches one or more brand name keywords of the plurality of brand name keywords associated with the brand name, identifying the brand name,
wherein the method is performed by a computing device comprising a processor.

11. A computer readable storage medium comprising a sequence of instructions, which when executed by one or more processors, perform steps of:
obtaining a plurality of category keywords associated with a category;
designating a subgroup of category keywords of the plurality of category keywords, that meet an affinity criteria for a brand name, as brand name keywords associated with the brand name;
receiving a search term;
determining that the search term is a brand name keyword of the plurality of brand name keywords associated with the brand name;
responsive to determining that the search term is a brand name keyword of the plurality of brand name keywords associated with the brand name, identifying the brand name.

12. The computer readable storage medium as recited in claim 11, wherein designating the subgroup of category keywords as brand name keywords comprises determining that each category keyword of the subgroup of category keywords is found in a document associated with the brand name.

13. The computer readable storage medium as recited in claim 12, wherein the document is a website associated with the brand name.

14. The computer readable storage medium as recited in claim 11, wherein selecting the subgroup of category keywords comprises determining that each category keyword of the selected subgroup of category keywords is found a predetermined number of times in a document associated with the brand name.

15. The computer readable storage medium as recited in claim 11, wherein obtaining the plurality of category keywords associated with the category comprises:
obtaining a plurality of brand names associated with the category;
obtaining a plurality of previously used query terms for searching for one or more brand names in the plurality of brand names.

16. The computer readable storage medium as recited in claim 15, wherein obtaining the plurality of category keywords associated with the category further comprises:
for each previously used query term,
determine a plurality of related keywords;
if at least a threshold number of related keywords in the plurality of related keywords match a plurality of product-intent keywords, designate the previously used query term as a category keyword.

17. The computer readable storage medium as recited in claim 16, wherein determining a plurality of related keywords for each previously used query term comprises:
performing a web search for the previously used query term to obtain to top k document results from the web search, wherein k is a predetermined number;
searching the top k document results for the occurrence of frequently queried words determined based on web search logs;
designating the most frequently queried words found in the top k document results for the previously used query term as related words for the previously used query term.

18. The computer readable storage medium as recited in claim 11, the steps further comprising presenting the brand name.

19. The computer readable storage medium as recited in claim 11, the steps further comprising
identifying a store name associated with the brand name;
presenting a store name associated with the brand name.

20. A computer readable storage medium comprising a sequence of instructions, which when executed by one or more processors, perform steps of:
obtaining a plurality of brand-specific product names;
for each brand-specific product name, performing steps comprising:
(a) determining a plurality of related keywords;
(b) if at least a threshold number of related keywords in the plurality of related keywords match a plurality of product-intent keywords, then designating the brand-specific product name as a candidate keyword;
(c) if the candidate keyword satisfies an affinity criteria for a brand name, then designating the candidate keyword as a brand name keyword of a plurality of brand name keywords for the brand name;
receiving a search term;
determining that the search term matches one or more brand name keywords of the plurality of brand name keywords associated with the brand name;
responsive to determining that the search term matches one or more brand name keywords of the plurality of brand name keywords associated with the brand name, identifying the brand name.
